(19) United States
(12) Patent Application Publication
(10) Pub. No.: US 2001/0004985 A1
(43) Pub. Date: Jun. 28, 2001

(54) Bucket for airless paint sprayer

(76) Inventor: John Pertschi, Hillsborough, NC (US)

Correspondence Address: Robert M. Downey, P.A., Suite 350, 150 East Palmetto Park Road, Boca Raton, FL, 33432, US

(21) Appl. No.: 09/756,968

(22) Filed: Jan. 9, 2001

Related U.S. Application Data
(63) Continuation of application No. 09/461,638, filed on Dec. 14, 1999.

(51) Int. Cl. B05C 21/00

(52) U.S. Cl. 220/570

(57) ABSTRACT

A bucket includes a side wall structure surrounding an interior and extending from a base to a top peripheral rim at an open top. The interior of the bucket includes an upper portion and a lower portion defining a well. A floor between the upper and lower portions surrounds a top of the well and is pitched so as to direct fluid into the well. A reduced size of the well relative to the upper portion of the bucket interior serves to gather fluid into a constricted volume reservoir for efficient pick-up through the distal end of a wand of an airless paint sprayer extending down through the open top and into the well of the bucket.

This application is a continuation application based on previously filed co-pending patent application Ser. No. 09/461,638 filed on Dec. 14, 1999 which is to be abandoned in favor of this application.

### BACKGROUND OF THE INVENTION

1. Field of the Invention

The present invention relates generally to paint containers for paint sprayers and, more particularly, to a paint bucket for holding paint being delivered through a wand of a powered airless paint sprayer.

1. Description of the Related Art

Powered airless paint sprayers are well known and are used extensively in residential and commercial environments for applying stains, lacquers, oil-based and latex paints to a variety of surfaces, including building structures and individual work pieces. These machines, which are typically powered by electricity, are more effective than conventional devices such as brushes and rollers. In particular, airless paint sprayers allow paint to be applied in a consistent, uniform manner with a high degree of efficiency, producing professional quality results in a reduced amount of time.

Generally, airless paint sprayers include a pump driven by a motor which removes paint from a can or bucket and forces the paint through a hose under pressure to a spray nozzle. Upon pulling a trigger on the spray nozzle, the paint is released in accordance with a desired sprayed array for painting a surface, such as a wall of a house or a building. In order to pick up the paint from the can or bucket, the airless sprayer includes a wand which extends downwardly from the pump to a distal end which is positioned below the surface of the paint contained in the bucket.

A problem arises when the paint level in the bucket lowers below the level of the end of the pick up wand, preventing further pick-up of paint through the wand despite the fact that a substantial quantity of paint remains in the bucket. In this instance, it is necessary to either add more paint to the bucket or position the bucket in a manner which brings the surface level of the paint above the end of the wand. Typically, painters will tilt the bucket in an attempt to gather the paint to one side so that the reservoir of paint becomes deeper, thereby enabling the wand to extend below the level of the paint. Alternatively, the bucket can be propped-up by placing objects below the bucket, thereby moving the end of the wand closer to the bottom of the bucket. Inevitably, when it is required to move the airless sprayer apparatus, the bucket, being tilted or propped-up in a less than sturdy manner, tips over causing the paint to be spilled on the floor.

Accordingly, there is a need for an improved bucket which is specifically designed for use with airless paint sprayers. Moreover, there is a need for an improved bucket which includes means for collecting and centralizing the paint in the bottom of the bucket, in a manner which enables the wand of an airless paint sprayer to remain below the paint surface level while the bucket remains secured to the apparatus in an upright manner, thereby minimizing the amount of unusable paint left in the bucket which cannot be picked up by the wand.

### SUMMARY OF THE INVENTION

The present invention is directed to a bucket for use with a powered airless paint sprayer machine for efficiently containing a charge of paint, stain, lacquer, or other like products for pick-up through the distal end of a wand of the paint sprayer. The bucket includes a side wall structure extending from a base to a top peripheral rim at an open top. A floor integrally formed with the side wall structure, within the bucket, divides the bucket into an upper portion and a lower portion. The upper portion of the bucket is surrounded by the side wall structure to define a first chamber between the floor and the open top of the bucket. A well in the lower portion includes a bottom and a vertical side wall structure extending from the bottom to an open top. The floor between the upper and lower portions surrounds the open top of the well and is pitched downwardly so as to direct fluid, such as paint, stain, lacquer, etc. into the well. A transverse cross-sectional area of the well measured on the horizontal plane between the vertical side wall structure, and defined by a surface of fluid contained therein, is substantially less than the transverse cross-sectional area of the first chamber measured on the horizontal plane between the surrounding side wall structure. This serves to narrow the well relative to the first chamber in the upper portion so that fluid is gathered into a constricted volume reservoir in the well for pick-up through the distal end of the wand of the airless paint sprayer which extends down through the open top of the bucket and into the well. In this manner, the efficiency of liquid pick-up is increased by minimizing the amount of paint, lacquer, stain, etc. which cannot be picked up through the wand and which is, thereby, left in the bottom of the bucket. A generally U-shaped rigid wire handle is pivotally attached, at opposite ends, to the side wall structure of the bucket to facilitate carrying of the bucket and supporting the bucket in operative position on the airless paint sprayer. The handle is specifically structured and positioned to support the bucket on the paint sprayer in a manner which maintains the distal end of the paint pick-up wand in close spaced relation to the bottom of the well in the bucket to thereby maximize the amount of liquid that is withdrawn from the bucket, with very little waste.

### OBJECTS AND ADVANTAGES OF THE INVENTION

In addressing the problems in the related art, as set forth above, it is a primary object of the present invention to provide an improved bucket for use with powered airless paint sprayers which is specifically designed to maximize the amount of paint which can be removed from the bucket through the wand of the airless paint sprayer apparatus.

It is another object of the present invention to provide an improved bucket for use with an airless paint sprayer apparatus, wherein a bottom of the bucket is provided with a reduced volume well for gathering paint in close proximity to the distal end of the pick up wand of the paint sprayer apparatus.

It is still a further object of the present invention to provide an improved bucket for use with an airless paint sprayer apparatus which is specifically designed to enable use of small amounts of paint, thereby eliminating the need for larger quantities of paint in the bucket in order to use the airless sprayer apparatus for small projects.

It is still a further object of the present invention to provide an improved bucket for use with an airless paint sprayer apparatus which can be used for production work as well as piece work.

It is still a further object of the present invention to provide an improved bucket which is adapted for use with a variety of models and brands of airless paint sprayer machines.

It is yet a further object of the present invention to provide an improved bucket for use with airless paint sprayers which enables paint to be transported or stored within the bucket.

It is still a further object of the present invention to provide an improved bucket for use with airless paint sprayers which is easy to clean and which includes no moving parts or hard-to-reach areas.

It is yet a further object of the present invention to provide an improved bucket for use with airless paint sprayers which allows for convenient stacking of multiple buckets, thereby facilitating ease of storage.

It is still a further object of the present invention to provide an improved bucket for use with airless paint sprayers which is specifically designed to direct to the pick up on the end of the wand of the airless sprayer, thereby eliminating the need for tilting or propping up the paint bucket and spilling of paint.

It is yet a further object of the present invention to provide an improved paint bucket which is adapted for use with a variety of models and brands of powered airless paint sprayers and wherein the bucket is further adapted for use with a standard paint roller system.

These and other objects and advantages of the invention will be more readily apparent with reference to the detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevation, in partial section, showing the paint bucket of the present invention;

FIG. 2 is a top plan view, in cross-section, taken along line 2-2 of FIG. 1;

FIG. 3 is a bottom plan view of the paint bucket taken along line 3-3 of FIG. 1; and

FIG. 4 is a side elevation, in partial section, showing the paint bucket of the present invention operatively positioned for use with an airless paint sprayer apparatus.

Like reference numerals refer to like parts throughout the several views of the drawings.

### DETAILED DESCRIPTION OF THE PREFERRED EMBODIMENT

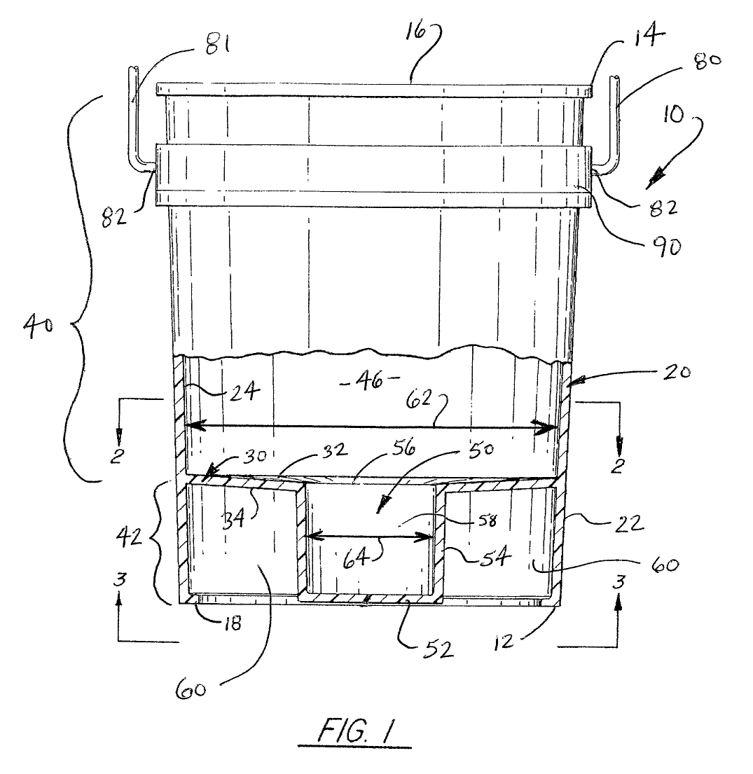

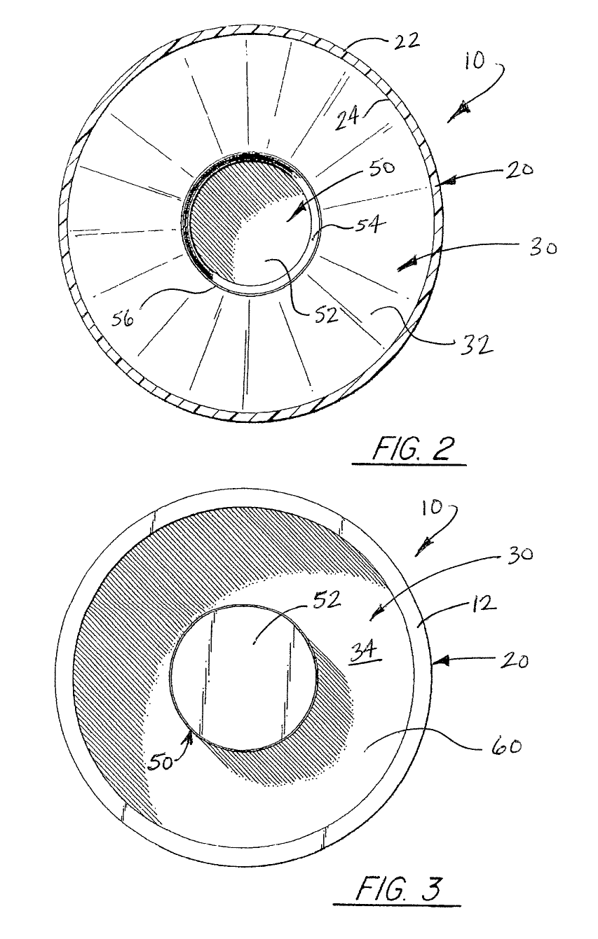

Referring to the drawings, and initially FIG. 1, the bucket of the present invention is shown and generally indicated as 10. The bucket 10 includes a base 12, a top rim 14 surrounding an open top 16, and a side wall structure 20 extending from the base 12 to the top rim 14. In a preferred embodiment, the side wall structure 20 is cylindrical and includes an outer surface 22 and an inner surface 24. The base 12 may be defined by the bottom terminal edge of the side wall structure 20 or, alternatively, an inwardly directed flanged lip 18 for providing increased ground surface engaging area to promote stability of the bucket when resting on a ground or floor surface.

A floor 30 within the bucket is integrally formed with the side wall structure and is surrounded by the side wall structure 20. The floor 30 is spaced above the base 12 and divides the bucket into an upper portion 40 and a lower portion 42. The floor includes a top surface 32 communicating with a first chamber 46 defined within the upper portion 40 of the bucket, and a bottom surface 34 exposed on an under side of the bucket. The first chamber 46 extends from the open top 16 to the floor 30 and is sized and configured for holding a charge of liquid, such as paint, lacquer, stain, or the like therein. The bucket 10 may be provided in various sizes, wherein the holding capacity of the first chamber 46 may vary. In typical embodiments, the holding capacity of the first chamber 46 is between 2 gallons and 5 gallons.

A well 50 is provided in the lower portion 42 of the bucket and is defined by a bottom 52 and a vertical wall structure 54 extending upwardly from the bottom 52 to an open top 56 in fluid communication with the first chamber 46. Accordingly, a fluid receiving reservoir 58 is defined within the well 50 and openly communicates with the first chamber 46 through the open top 56. The vertical wall structure 54 is integral with the floor 30. In a preferred embodiment, the vertical wall structure 54 is cylindrical and is centrally positioned below the first chamber 46 so that the floor 30 surrounds the open top 56 of the well 50 in an annular configuration. The top surface 32 of the floor 30 is sloped downwardly from the interior surface 24 of the side wall structure 20 to the open top 56 of the well 50 so that fluid within the first chamber 46 is directed along the top surface 32 of the floor 30, by gravity flow, into the well 50. In a preferred embodiment, the floor 30 is sloped at an angle of between 2° and 5° from horizontal.

A hollow cavity 60 defined between the vertical wall structure 54 of the well 50 and the surrounding side wall structure 20 in the lower portion 42 is open through the bottom of the bucket between the bottom 52 of the well and the base 12.

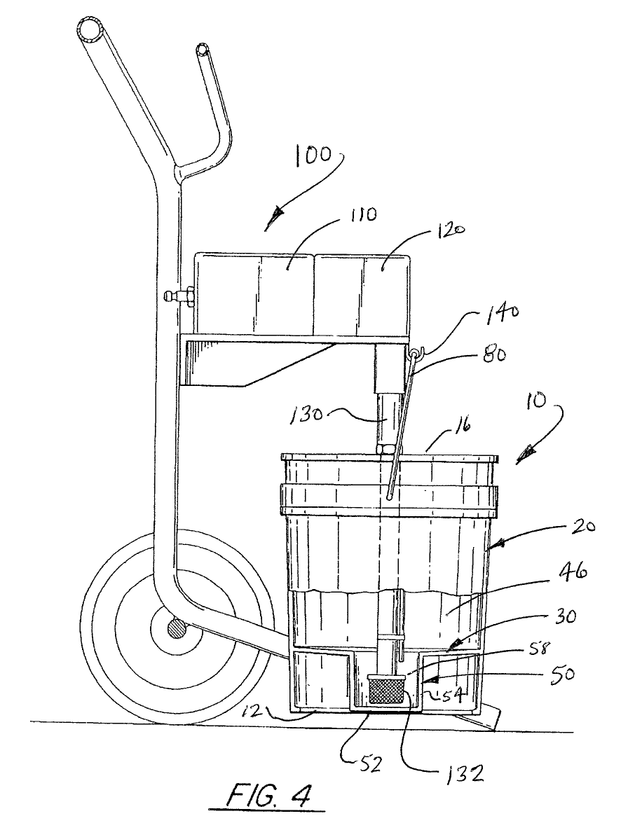

A transverse cross-sectional area of the well 50, measured on a horizontal plane, as indicated by the line 64, is substantially less than the transverse cross-sectional area of the first chamber 46, measured on a horizontal plane, as indicated by arrows 62, between the surrounding side wall structure 20. It is noted that the transverse distance across the first chamber 46 (i.e., the diameter) may vary from the open top 16 to the floor 30. Further, it is noted that the transverse distance (i.e., the diameter of the well) across the reservoir 58 of the well 50 may vary from the open top 56 to the bottom 52. Notwithstanding, the maximum diameter of the well 50 is still substantially less than the minimum diameter of the first chamber 46. In this manner, the volume of the reservoir 58 within the well 50 is constricted relative to the volume of the first chamber 46. This serves to gather liquid into a confined, somewhat narrow area for more efficient pick-up through the distal end 132 of a wand or pick-up tube 130 of a powered airless paint sprayer apparatus 100, as shown in FIG. 4.

Handle means 80 are provided for carrying the bucket 10 in the same general manner as a conventional bucket. The handle means comprises a generally U-shaped rigid wire 81 which is attached to the side wall structure 20 of the bucket 10, at opposite ends 82. In a preferred embodiment, the ends 82 are pivotally received within sockets formed in a collar 90 formed about the side wall structure 20. The collar 90 is defined by an area of increased wall thickness to provide rigidity to the wall structure 20 and means for securely anchoring the distal ends 82 of the handle to the bucket. The handle, being pivotally attached to the bucket, can be raised, as shown in FIG. 4, so that the handle 80 is received and supported on a hook member 140 of the airless paint spraying apparatus 100, as seen in FIG. 4. The bucket 10 is particularly suited for use with a powered airless paint spraying apparatus, such as the type shown in FIG. 4. Specifically, the handle 80 is adapted to be received on the hook portion 140 to support the bucket 10 in operative position on the paint spraying apparatus 100. Moreover, the distance from the top center of the handle, when in the raised position, and the bottom 52 of the well 50 is specific to the length of the wand. More particularly, the handle is structured and disposed to support the bucket on the paint spraying apparatus so that the wand 130 of the paint spraying apparatus 100 extends downwardly through the open top 16 and into the well 50 with the distal end 132 of the wand 130 maintained in close, spaced relation to the bottom 52 of the well. It is preferable that the distal end 132 of the wand 130 be spaced no more than 1 inch above the bottom 52 of the well. In this manner, the liquid which is gathered within the constricted area of the reservoir 58 of the well 50 is efficiently picked up through the distal end 132 of the wand 130 and delivered to a pump 120 powered by a motor 110 of the paint spraying apparatus 100. The constricted volume of the reservoir 58, created by the reduced diameter of the vertical wall structure 54, serves to substantially minimize the amount of liquid which remains within the bottom of the bucket (i.e., the bottom of the well 50) and which cannot be picked up through the wand 130. Accordingly, the bucket 10 of the present invention enables a user of an airless paint spraying apparatus to use smaller amounts of paint, stain, lacquer, etc., in an efficient manner, with less waste and with a substantially reduced likelihood of spills.

While the instant invention has been shown and described in accordance with a preferred and practical embodiment thereof, it is recognized that departures may be made from the instant disclosure which, therefore, should not be limited except as set forth in the following claims as interpreted under the doctrine of equivalents.

What is claimed is:

1. A bucket for containing a charge of liquid to be delivered to a spraying apparatus through a distal end of a wand of the spraying apparatus, an improved bucket comprising:
a base;
a top rim surrounding an open top;
a side wall structure extending between said base and said top rim;
a floor surrounded by said side wall structure and defining an upper portion and a lower portion of said bucket;
said side wall structure surrounding a first chamber defined between said floor and said open top;
a well formed in said lower portion and disposed in fluid communication with said first chamber, said well including a bottom and a vertical wall structure extending from said bottom to a top opening of said well, and said well being structured and disposed for receipt of the distal end of the wand therein;
said floor being sloped downwardly from said side wall structure to said top opening of said well to thereby direct gravity assisted fluid flow from said first chamber into said well; and
means for supporting said bucket on the spraying apparatus so that the distal end of the wand is positioned and maintained within the well in close, spaced relation above the bottom of the well.

2. The bucket as recited in claim 1 wherein a transverse cross-sectional area of said well measured on a horizontal plane between said vertical wall structure is less than a transverse cross-sectional area of said first chamber measured on a horizontal plane between said surrounding side wall structure.

3. The bucket as recited in claim 2 wherein a volume of said well is constricted relative to a volume of said first chamber.

4. The bucket as recited in claim 3 wherein said well is centrally positioned and disposed relative to said side wall structure.

5. The bucket as recited in claim 4 wherein said floor is disposed in surrounding relation to said opening of said well.

6. The bucket as recited in claim 5 wherein said side wall structure is cylindrical.

7. The bucket as recited in claim 6 wherein said vertical wall structure of said well is cylindrical.

8. The bucket as recited in claim 7 wherein said floor is annular and sloped radially inward and downward towards said top opening of said well.

9. The bucket as recited in claim 8 wherein said floor is sloped downwardly and inwardly from said side wall structure to said top opening of said well at an angle of between 2° and 5° from horizontal.

10. The bucket as recited in claim 1 wherein said means for supporting said bucket on the spraying apparatus includes handle means attached to said side wall structure for supporting said bucket in an operative position on the spraying apparatus with the distal end of the wand positioned and maintained within said well in close, spaced relation above said bottom of said well.

11. The bucket as recited in claim 10 wherein said handle means is pivotally attached to said side wall structure and movable between a lowered position and a raised position.

12. The bucket as recited in claim 11 wherein said side wall structure includes an annular collar for reinforcing said side wall structure and for supporting the attachment of said handle means thereto.

13. A bucket in combination with a spraying apparatus, said combination comprising:
a pump on the spraying apparatus supported above a ground surface;
a wand extending downwardly from said pump and terminating at a distal end, said distal end being structured and disposed for intake of fluid therethrough for delivery to said pump;
said bucket including a base, a top rim surrounding an open top, a side wall structure extending between said base and said top rim, and a floor surrounded by said side wall structure and defining an upper portion and a lower portion of said bucket;
said side wall structure surrounding a first chamber defined between said floor and said open top;
a well formed in said lower portion and disposed in fluid communication with said first chamber, said well including a bottom and a vertical wall structure extending from said bottom to a top opening of said well, and said well being structured and disposed for receipt of said distal end of said wand therein;
said floor being sloped downwardly from said side wall structure to said top opening of said well to thereby direct gravity assisted fluid flow from said first chamber into said well; and
means for supporting said bucket on said spraying apparatus so that said distal end of said wand is positioned and maintained within said well in spaced relation above said bottom of said well.

14. The combination as recited in claim 13 wherein said means for supporting said bucket on said spraying apparatus includes handle means attached to said side wall structure for supporting said bucket in an operative position on said spraying apparatus.

15. The combination as recited in claim 14 wherein said side wall structure includes an annular collar for reinforcing said side wall structure and for supporting the attachment of said handle means thereto.

16. The combination as recited in claim 13 wherein a transverse cross-sectional area of said well, measured on a horizontal plane between said vertical wall structure, is less than a transverse cross-sectional area of said first chamber, measured on a horizontal plane between said surrounding side wall structure.

17. The combination as recited in claim 16 wherein a volume of said well is constricted relative to a volume of said first chamber.

18. The combination as recited in claim 17 wherein said well is centrally positioned and disposed relative to said side wall structure.

19. The combination as recited in claim 18 wherein said floor is disposed in surrounding relation to said opening of said well.

20. The combination as recited in claim 19 wherein said floor is sloped downwardly and inwardly from said side wall structure to said top opening of said well at an angle of between 2° and 5° from horizontal.
